(19) United States
(12) Patent Application Publication
(10) Pub. No.: US 2005/0180174 A1
(43) Pub. Date: Aug. 18, 2005

(54) CC-CC low power converter

(75) Inventors: Ivo Barbi, Florianopolis (BR); Kefas Damazio Coelho, Florianopolis (BR)

Correspondence Address: FLESHNER & KIM, LLP, P.O. BOX 221200, CHANTILLY, VA, 20153, US

(73) Assignee: WEG S.A.

(21) Appl. No.: 11/032,043

(22) Filed: Jan. 11, 2005

(30) Foreign Application Priority Data
Feb. 2, 2004 (BR) PI 0400591-0

(51) Int. Cl. H02M 3/335

(52) U.S. Cl. 363/16

(57) ABSTRACT

“LOW POWER CC-CC CONVERTER”, characterized by the fact that it can be configured as forward or flyback mode converter, which takes off from an insulated converter with two switches, in which the two switches in series substitute a single switch in S1 or S2, determining that this converter rely on four switches.

This report deals with an invention patent that proposes new topology of a Low Power CC-CC converter with high input voltage, being that such topology has voltage reduction characteristics in the power switches by being half input voltage, having also a simplified command form, as the four switches obey the same command signal.

From the creation of the transistor in the beginning of the 50's and the development of integrated circuits in the 60's, designers of electronic equipment for several purposes have sought power converters of even smaller size, more efficient, cheaper and more reliable.

The emergence of quick power transistors helped the technological ascension of switched sources. The most common non-insulated CC-CC converters that allow for the “reduction” of voltage, present on active switch a blocking voltage equal to the input voltage.

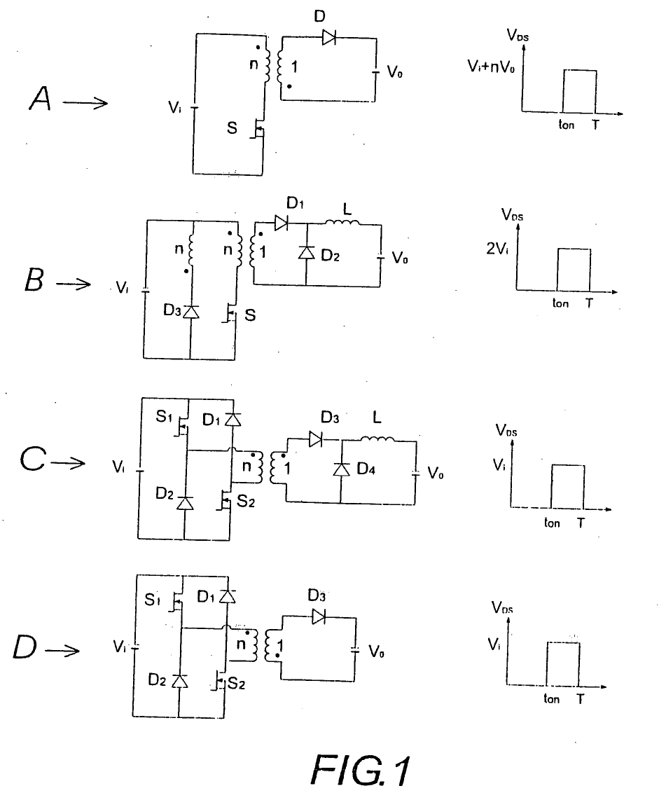

In the same manner as the non-insulated converters, the most commonly known insulated converters show blockage voltage values on switches never below the input voltage, as shown in FIG. 1, where they are schematically represented from top to bottom: a) flyback converter; b) forward converter; c) two-switch forward converter; and d) two-switch flyback converter.

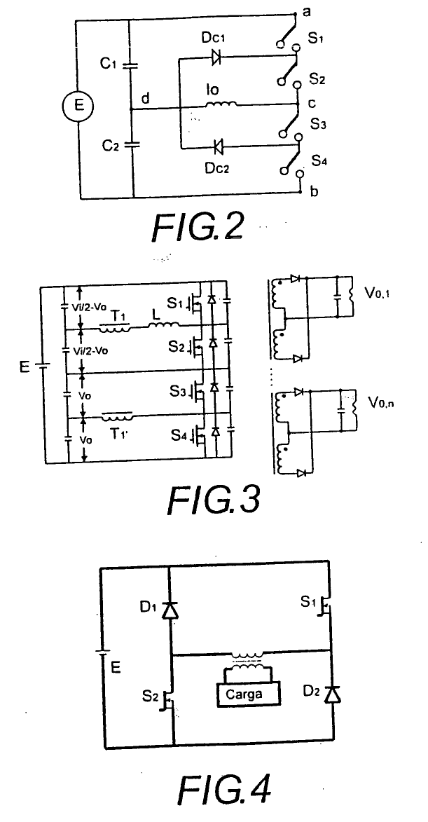

Reduction of this voltage has been studied, and intense works conducted with NPC (neutral point clamped) type cells (FIG. 2). For higher powers, it is sought, besides voltage reduction in switches, their smooth switching, therefore increasing yield and reducing switching loss.

Presented as an in-line converter with the arrangement of switches, Maranesi tested a converter controlled by phase dislocation destined for small powers with reduction of voltages blockage from MOSFETs. This is one of the few trials found in literature on auxiliary sources. This converter presents reverse tension in switches at half input voltage minus output voltage reflected on upper switches, and output voltage reflected on lower ones (FIG. 3).

In face of the state of technique described above, this patent was developed treating the lower power CC-CC converter, which will be described with reference to the drawings listed/described below:

FIG. 1 shows, in comparative manner, four types of basic insulated converters and reverse voltage on main switch, where a) corresponds to flyback converter; b) to two-switch forward converter; c) corresponds two-switch forward converter; and d) corresponds to two-switch flyback converter;

FIG. 2 shows a diagram of an NPC switch cell;

FIG. 3 shows an “in-line” converter diagram with voltage reduction in the MOSFETs for low powers;

FIG. 4 shows an insulated CC-CC two-switch converter;

FIG. 5 shows an insulated CC-CC four-switch converter;

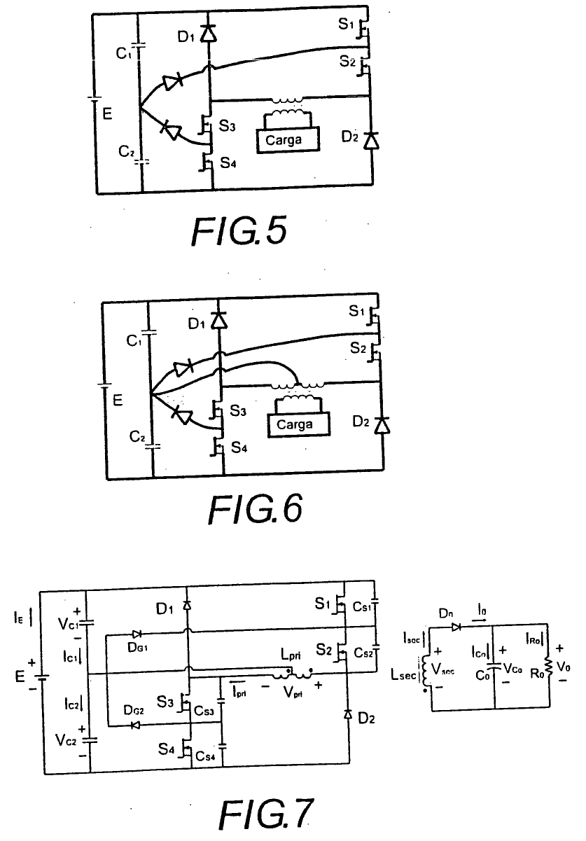

FIG. 6 shows an insulated CC-CC four-switch converter and balanced voltage as proposed by the present patent;

FIG. 7 shows diagram of a flyback converter-with-four-inline-switches such as the one proposed by the present patent; and

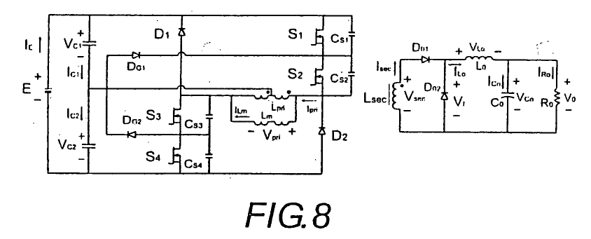

FIG. 8 shows a diagram if a forward-converter-with-four-inline-switches, as the one proposed by this invention patent.

In conformity with what is illustrated in the above listed figures, this patent proposes a low power CC-CC converter that can either be configured as converter in flyback mode or forward mode.

In general, the objective of this patent is to provide a converter that allows the continued conversion of high voltage to lower voltages in insulated and simplified form with reduced blockage on switches.

The invention, initially comprises of an insulated converter with two switches. Thus explained, this converter can function as flyback as well as forward, and has as advantage the fact that the voltage on the switches during the blockage will be equal to the voltage of the input source (FIG. 4).

Next, the two switches in series are placed in the place of one substituting S1 as well as S2. Now, the converter has four switches. The macroscopic functioning characteristic continues being the same, but with blockage voltage in the switches being half input voltage (FIG. 5).

However, to ensure the blockage of this voltage, it is necessary to divide the voltage from the source into two other virtual sources, or two input capacitors. Two clamping diodes are added, providing as such a link blocking the voltage on the switches.

For the voltage balance of the capacitors to be ensured, the primary transformer is divided into two identical windings. The medium point of this primary winding is connected to the medium point of the input capacitors (FIG. 6). Therefore, the proposal's idea: a converter that allows the clamping of blockage voltage on switches as half input source voltage. The converter shows intrinsic balance to structure functioning and the same characteristics of command and power transfer of its predecessors, functioning in flyback or forward modes.

The classic flyback converter shows a simple and cheap solution. This characteristic is mainly due to the fact that the flyback topology does not have an output inductor, thus having a magnetic element, regardless of the number of outputs.

However, the flyback mode of power transfer has as aggravator the greater current peaks in the switches as this type of continuous conduction is avoided due to the existence of a zero in the right semi-plan which can lead to instability. There may also be saturation problems in the nucleus storing magnetizing energy (in the flyback the energy is stored in the magnetic field of the transformer core).

The classic flyback converter also shows high voltage on switches when they are blocked. This voltage is equal to the supply voltage plus the output voltage reflected on the primary.

The converter treated herein, called four-switch-inline-flyback (FIG. 7) has power transfer characteristics quite similar to the classic flyback converter. These characteristics pointed out as principal are: unidirectional form of transfer, operation in discontinued conduction mode and analogical functioning to buck-boost converter.

The forward converter has been widely used for 50 years, mainly in small power sources. The energy transfer mechanism of this converter is well known by the academic community as well as specialized engineers in switched sources: power is transferred when the switch is conducting.

Among many challenges that guided the history of the forward converter is mentioned the reduction of switch losses, mainly at conduction input, and reduction of reverse voltage on the switch during the time it stays open.

In this patent, the new topology shows simple transfer function with reduction in switch voltage.

The converter treated herein, in this case, presents the denomination: four-switch-inline-forward for having power transfer characteristics similar to those of the forward converter. These characteristics are pointed out as: transfer in unidirectional form and demagnetizing of transformer. The innovation presented in this converter consists of the fact that it has four switches arranged in series with the load. Its great advantage is the clamping of voltage on switches at half input voltage as shown in FIG. 8.

1. “LOW POWER CC-CC CONVERTER”, characterized by the fact that it can be configured as forward or flyback converter, which takes off from an insulated converter with two switches, in which the two switches in series substitute a single switch in S1 or S2, determining that this converter rely on four switches.

2. “LOW POWER CC-CC CONVERTER”, according to claim 1, characterized by the fact that the converter treated herein shows voltage blockage on switches with half the input voltage.

3. “LOW POWER CC-CC CONVERTER” according to claim 1, characterized by the fact that to ensure input voltage blockage, source voltage is divided into two virtual sources, or two input capacitors, being that two clamping diodes are added and as such provide voltage blockage link on switches.

4. “LOW POWER CC-CC CONVERTER”, according to claim 1, characterized by the fact that for the voltage balance of the capacitors to be ensured, the primary of the transformator is divided into two identical windings; the medium point of this primary winding is connected to the medium point of the input capacitors.

5. “LOW POWER CC-CC CONVERTER”, according to claim 1, characterized by the fact that on the flyback mode, the converter treated herein has four switches arranged in series with load allowing clamping of voltage on switches at half input voltage and has power transfer characteristics quite similar to those of the classic flyback converter.

6. “LOW POWER CC-CC CONVERTER”, according to claim 1, characterized by the fact that on forward mode, the converter treated herein has four switches arranged in series with load allowing the clamping of voltage on switches at half input voltage, and power transfer characteristics quite similar to those of the classic forward converter.

7. “LOW POWER CC-CC CONVERTER” according to claim 2, characterized by the fact that to ensure input voltage blockage, source voltage is divided into two virtual sources, or two input capacitors, being that two clamping diodes are added and as such provide voltage blockage link on-switches.
